(19) United States
(12) Patent Application Publication
(10) Pub. No.: US 2010/0179689 A1
(43) Pub. Date: Jul. 15, 2010

(54) METHOD OF TEACHING ROBOTIC SYSTEM

(75) Inventor: Chyi-Yeu Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: National Taiwan University of Science and Technology, Taipei (TW)

(21) Appl. No.: 12/350,969

(22) Filed: Jan. 9, 2009

(51) Int. Cl. G05B 19/04

(52) U.S. Cl. 700/250

(57) ABSTRACT

First, an object model library and an operation module library are provided. The object model library contains at least an object model geometrically similar to a real object to be processed. The operation module library contains at least an operation module for each operation to be performed. Then, for each real object to be processed, a virtual object is defined by association with an object model in the object model library and by specification of the object model's geometric parameters. Subsequently, for each operation to be performed, the operation is defined by selecting an operation module from the operation module library and specifying its operation parameters. Optionally, for each virtual object defined, at least a two-dimensional image previously taken of the corresponding real object is associated with the virtual object.

### BACKGROUND OF THE INVENTION

1. Field of the Invention

The present invention generally relates to robotic systems, and more particularly to a method of teaching robotic system such that the robotic system is capable of manipulating objects in accordance with their analogy to predefined object models.

2. Description of Related Art

In the present specification, a robotic system is referred to a physical system that is artificial, moves with one or more axes of rotation or translation, programmable, can sense its environment, and is able to manipulate or interact with objects within the environment using automatic control, a preprogrammed sequence, or artificial intelligence.

In the past decade, there are rapid developments in intelligent robotic systems and there are even some commercialized products. Typical examples include Roomba, a vacuum cleaning robot by iRobot®, AIBO, a robotic pet designed and manufactured by SONY®, and ASIMO, a humanoid robot created by Honda®, to name just a few. Despite that they embody decades of advanced research, these robotic systems are still considered more of an entertainment ‘toy.’ This is mainly because that even a very simple (to human) dexterous coordinated movement like pouring water from a bottle into a cup is very difficult for a robotic system to ‘learn.’

On the other hand, it is estimated that there are over a million industrial robots, also referred to as factory or service robots, in operation worldwide for tasks which require speed, accuracy, reliability or endurance, especially in automobile and electronic industries. In contrast to the autonomous robots such as Roomba, AIBO, and ASIMO, these industrial robots excel human performance in highly defined and controlled tasks. That is, the work pieces are required to be individually and precisely positioned on a belt, instead of being piled together on a pallet. However, for these industrial robots, even some slight change would require days or even weeks of re-programming and modification.

Therefore, there are vision guided industrial robots to compensate for these inflexibilities. A vision-guided robotic system is a robotic system whose sense of its environment and the objects within the environment is mainly through one or more built-in image capturing and/or laser devices. For example, M-420iA produced by FAUNC® is capable of grasping up to 120 different work pieces on a transmission belt by using high-speed camera system to control the robot's two arms. A typical scenario of these vision-guided robots is as follows. The robot is programmed to position a camera and adjust the lighting to an optimal image capture location. A software program then processes the captured image and instructs the robot to make corrections for the positions and orientations of the work pieces. These vision-guided robots are indeed more flexible than ‘blind’ robots. Moving one object from one location to another location might be easier to program but these robots still require a lengthy training and integration lead time to even accommodate a simple part change. By these observations, it seems that the most significant obstacle for the robotic system to become mainstreamed is that it can conduct only one type of job—pick and place. To introduce any new kind of job for the robotic system, it simply takes too much time to teach and therefore too costly for the robotic system to perform a new ‘trick.’ Even for an industrial robot, arm motion teaching is difficult for non-fixed trajectories.

To make teaching robotic system a simpler task, the present inventor believes that the concept of analogy could be a key. Analogy plays a significant role in human problem solving, decision making, perception, memory, creativity, emotion, explanation and communication. It is behind basic tasks such as the identification of places, objects and people, for example, in face perception and facial recognition systems. It has been argued that analogy is ‘the core of cognition.’ If the analogical capability is in some way incorporated into a robotic system, the robotic system could be taught much faster than those conventional work-from-the-ground-up approaches.

### BRIEF SUMMARY OF THE INVENTION

A novel method in teaching a robotic system is provided herein with significantly reduced training time and effort by using analogy. The robotic system must contain at least the usual manipulating hardware and computing hardware.

An embodiment of the method contains the following major steps. First, an object model library and an operation module library are provided. For each real object to be processed by the robotic system, there is at least an object model defining a three-dimensional shape at least geometrically similar to the real object or there are two or more object models where their defined shapes could be combined to be at least geometrically similar to the real object. Each object model has a number of pre-determined geometric parameters describing the three-dimensional shape. For each operation to be performed on the real objects, there is at least an operation module contained in the operation module library and each operation module has a number of pre-determined operation parameters for specifying at least a target of the operation and additional pieces of information that are relevant to the operation to be performed on the target(s).

Then, for each real object to be processed, the definition of a virtual object is provided. The virtual object definition contains a unique name for the virtual object, a reference to an object model or a combination of a number of object models defined in the object model library, and specifications of values for the geometric parameters of the object model(s) in accordance with the real object.

Subsequently, for each operation to be performed on the real object(s), a definition of the operation is provided. The operation definition contains a reference to an operation module contained in the operation module library, and specifications of specifications of values for the operation parameters in accordance with the virtual object(s) representing the real object(s) and the operation to be performed.

Optionally, if the robotic system to be taught has at least an image capturing device, then, for each virtual object defined, at least a two-dimensional image previously taken of the real object represented by the virtual object is provided and associated with the virtual object. After this step, a task description for the robotic system is completed, which contains one or more virtual object definitions corresponding to the real object(s) to the processed, one or more operation definitions corresponding the operation(s) to be performed on the real object(s), and, optionally, one or more images of the real object(s) associated with the corresponding virtual object(s).

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is a schematic diagram showing a robotic system to be taught by the present invention.

FIG. 1b is a schematic diagram showing a software system according to the present invention for teaching the robotic system of FIG. 1a.

FIG. 2a is a schematic diagram showing two real objects to be processed by the robotic system of FIG. 1a.

FIG. 2b is a schematic diagram showing how a first real object of FIG. 2a is approximated by a combination of two primitive shapes defined in the object model library of the present invention.

FIG. 2c is a schematic diagram showing how a second real object of FIG. 2a is approximated by a complex shape defined in the object model library of the present invention.

FIG. 2d is a schematic diagram showing the additional pieces of information provided during the operation definition step of the present invention.

FIGS. 2e and 2f are schematic diagrams showing the intelligent trajectory planning of the robotic system based on the information provided by the geometric parameters of the virtual objects and the operation parameters of the operation modules.

FIG. 2g is a schematic diagram showing the task description produced by the present invention.

FIG. 3a is a flow diagram showing the major steps in teaching a robotic system of FIG. 1a according to an embodiment of the present invention.

FIG. 3b is a flow diagram showing the major steps in teaching a robotic system of FIG. 1a according to another embodiment of the present invention.

### DETAILED DESCRIPTION OF THE INVENTION

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention does not impose any requirement on the robotic system to be of a specific type. The robotic system could be legged or wheeled or even stationary; or the robotic system could have a humanoid form with two arms, or could a factory stationary robot having a single arm. The usage of the robotic system is also not limited; it could an autonomous domestic robot for house keeping or an industrial robot for electronic parts' pick-and-place.

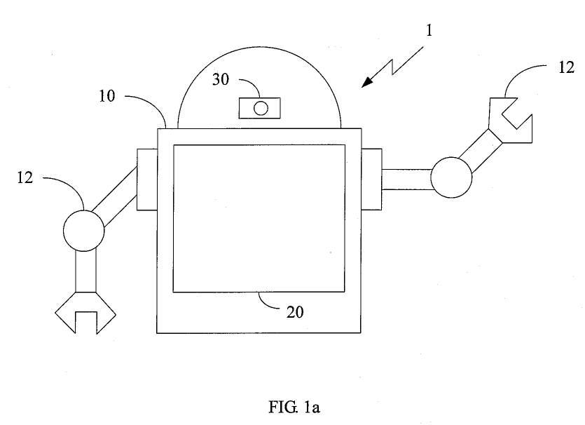

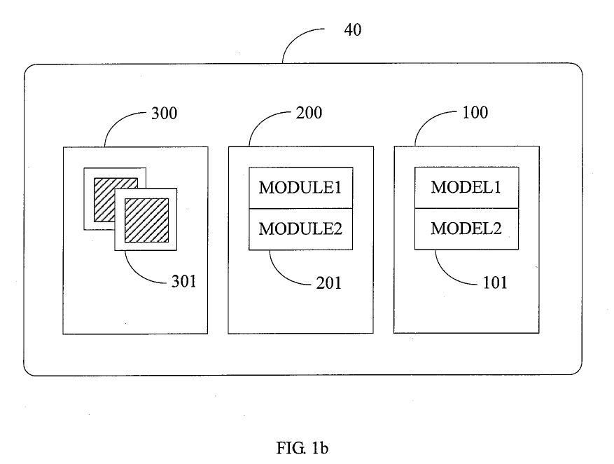

As illustrated in FIG. 1a, a robotic system 1 according to the present invention, like any conventional robot, does have appropriate object manipulating hardware to process real objects, such the body 10 and at least an arm 12 as shown in the drawing as well as various motors and actuators (not shown) driving the body 10 and the arms 12. The details of the manipulating hardware should be quite straightforward to a person skilled in the related art. The robotic system 1 also contains, again like any conventional robot, appropriate computing hardware 20 such as processor, controller, memory, storage, etc. (not shown) for the control of the manipulating hardware 10.

According to the present invention, the robotic system 1 is to be taught to perform operation on one or more real objects and the robotic system 1 must have some optical perception means to ‘see’ the real objects. The optical perception means may include, but is not limited to, image capturing device such as CCD (charge coupled device) camera capable of taking two-dimensional photographic pictures and 3D laser scanner capable of obtaining three-dimensional profiling data of the real objects. In other words, the robotic system 1 should have at least an image capturing device, or at least a 3D laser scanner, or both. For simplicity, in the following, the robotic system 1 is assumed to contain at least an image capturing device 30 such as a CCD camera. The image capturing device 30 could be built into the body 10 of the robotic system 1 such as one on the head of a humanoid robot or one on the arm of a service robot. The image capturing device 30 could also be one external to the body 10 of the robotic system but connected to the robotic system 1 via wired or wireless communication means, such as a camera positioned right on top of a transmission belt and connected to a service robot working on the parts delivered on the transmission belt. This communication means allows the images captured by the image capturing device 30 to be delivered to the computing hardware 20 for processing.

To teach the robotic system 1 to perform some specific task, a software system 40 is provided, as illustrated in FIG. 1b. An operator (i.e., the ‘teacher’ of the robotic system 1) programs the specific task in the environment provided by the software system 40 and generates a ‘task description’ for the robotic system 1's computing hardware 20 so that the robotic system 1 could perform the task successfully. In other words, the operator teaches the robotic system 1 using the software system 40. Please note that the software system 40 could be running on the same computing hardware 20 and the task description from the software system 40 is directly processed by the computing hardware 20 to perform the task. Alternatively, the software system 40 is executed on a separate computing platform and the task description from the software system 40 is loaded onto the computing hardware 20 (via some wired or wireless communication means) so that the robotic system 1 could perform the task accordingly.

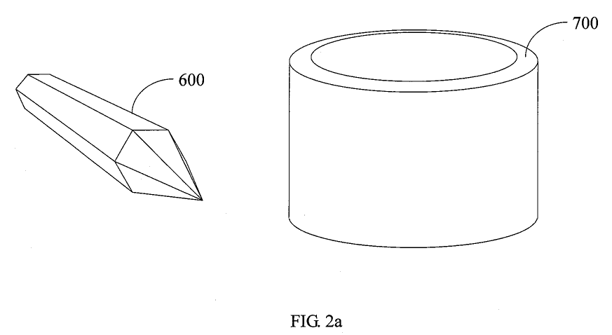

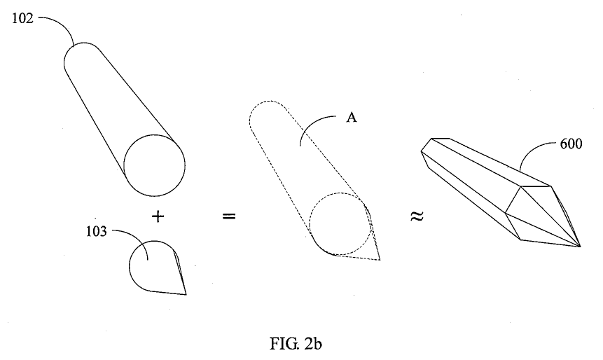

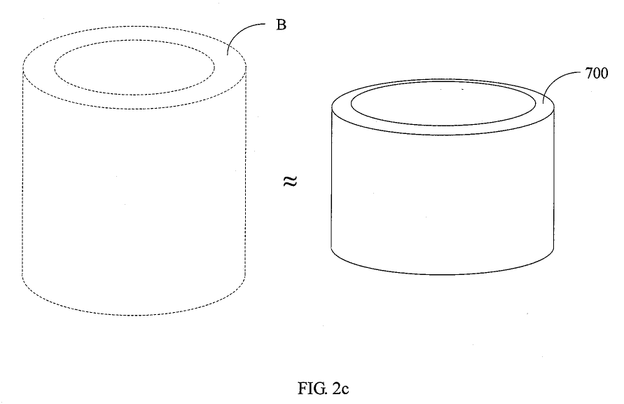

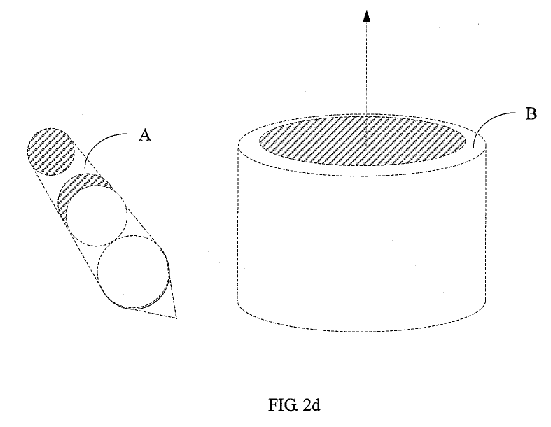

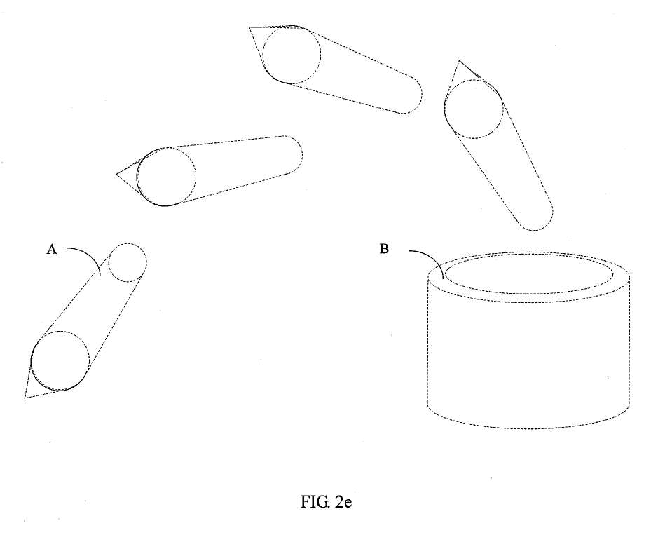

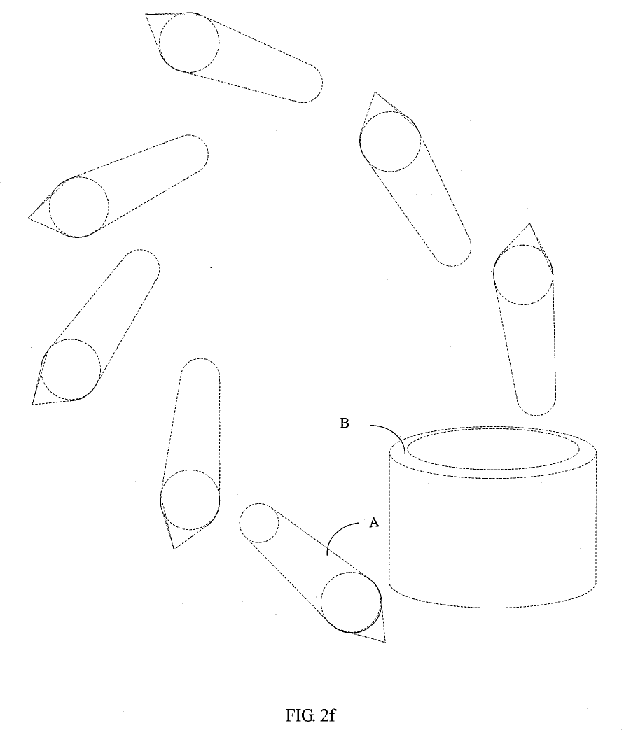

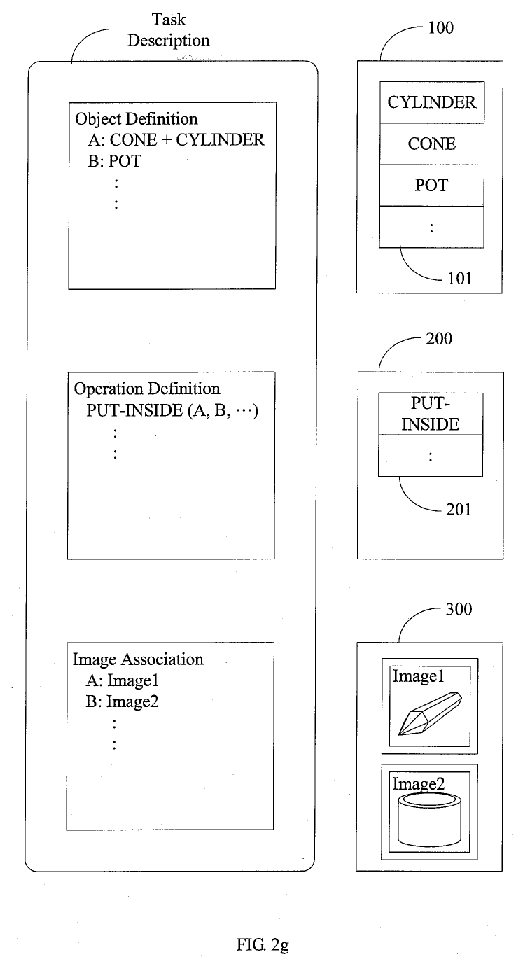

The first step of teaching the robotic system 1 is to define the real objects to be processed by the robotic system 1. For example, as illustrated in FIG. 2a, the robotic system 1 is to be taught to process a first real object 600 (i.e., a pen) and a second real object 700 (i.e., a brush pot). This object definition step requires a preliminarily prepared object model library 100. As illustrated in FIG. 1b, the object model library 100 is part of the software system 40 and contains at least a number of object models 101 of primitive shapes stored in a file, a database, or similar software construct. The term ‘primitive shape’ is commonly used in 3D modeling of computer graphic and CAD systems. Primitive shapes such as spheres, cubes or boxes, toroids, cylinders, pyramids, etc. are considered to be primitives because they are the building blocks for many other shapes and forms. Qualitatively, it is difficult to give the term a precise definition. From observation, they share some common shape features: (1) they usually contain only straight edges; (2) they usually contains only simple curves with no points of inflection; and (3) they usually cannot be broken down into other primitive shapes. As mentioned above, the main idea of the present invention is to incorporate analogical capability to teaching the robotic system 1, there must be some ‘base’ to be analogous to. The object models 101 of the object model library 100 are exactly the ‘base.’

The reasoning of having the object model library 100 is based on the assumption that most of real-life objects could be approximated by one of these primitive shapes or a combination of two or more of these primitives through some simple binary relations (addition, subtraction, etc.). For example, as illustrated in FIG. 2b, for the real object 600 (i.e., pen), the object model library 100 contains an object model 101 of a cylinder 102 and another object model 101 of a cone 103, and the real object 600 could be approximated by a simple addition of the cone 103 to an end of the cylinder 102. Please note that the primitive shapes of cylinder 102 and cone 103 do not have the specific details of the real object 600 such as the hexagonal cross section. The most important thing is that a primitive shape is geometrically similar to and therefore provides an approximation to a real object, or a part of the real object, to be processed by the robotic system 1.

Additionally, the object model library 100 could also contain one or more object models 101 that are not primitive and even identical to or substantially similar to the real object to be processed. For example, as illustrated in FIG. 2c, for the real object 700 (i.e., brush pot), the object model library 100 contains an object model 101 of a tubular shape that are geometrically identical to the real object 700. However, the tubular shape is not primitive as it can be represented by a primitive cylinder subtracting another primitive cylinder having a smaller diameter. Accordingly, it is possible that the object model library 100 could contain object models of complex geometric shapes such as a coke bottle, a wrench, etc. that are modeled exactly after the real objects to be processed.

The object model 101 of each primitive or complex shape contains a number of geometric parameters. The geometric parameters may be different from one object model 101 to another of a different shape. For example, the object model 101 of the cylinder 102 could be represented in a vector form as follows:

CYLINDER={l, d}

where 1, d are the length and diameter of the cylindrical shape; the object model 101 of the cone 103 could be represented as follows:

CONE={d, h}

where d, h are the base diameter and height of the conical shape; and the object model 101 of a pot could be represented as follows:

POT={l, d, w}

where l, d, and w are the length, diameter, and the thickness of the wall of the pot shape.

Please note that the object model library 100 could contain only object models 101 of primitive shapes. Alternatively, the object model library 100 could contain object models 101 of both primitive shapes and complex/custom shapes. Please also note that additional object models 101 could by added later to the object model library 100 if required after the object model library is established.

As mentioned earlier, the object model library 100 provides the ‘base’ for analogy. To achieve this feature, the object definition step allows the operator to define a virtual object for each real object to be processed. For each virtual object thus defined, there is a unique name for the virtual object and the name (and, therefore, the virtual object) is associated an object model 101 or a combination of two or more object models 101 of the object model library 100. For the example of FIG. 2a, two virtual objects are defined as follows by using exemplary pseudo codes:

Virtual Object
A: CONE+CYLINDER;
B: POT;
   where the virtual object A is specified to have all the geometric parameters of a cone and the geometric parameters of a cylinder when the cone is added to an end of the cylinder so as to approximate the pen 600; and the virtual object B is specified to have all the geometric parameters of a pot shape so as to approximate the brush pot 700.

Please note that even though the above example is described using a programming language scenario but the same definition process could be and actually more preferably accomplished in a graphical environment with point and click operations just like using a CAD system such as AutoCAD®. It could be easily imagined for people of the related art that the virtual objects are defined in the graphical environment just like creating 3D models in AutoCAD® by selecting and combining primitive shapes. In addition to the unique names and associations with the object models, the software system 40 then allows the operator to specify the values of the geometric parameters in accordance with their corresponding real objects. Again, using pseudo codes, this could be represented as follows:

Virtual Object
A: CONE(d=2 cm, h=2 cm)+CYLINDER(l=8 cm, d=2 cm);
B: POT(l=5 cm, d=3 cm, w=0.5 cm);
   Again, if in a graphical environment, this could be achieved by extruding and scaling the primitive shapes, and/or manual entry of the parameter values.

As a brief summary, the object definition step involves, for each real object to be processed, the definition of a virtual object by selecting a shape or combining a number of shapes from the object model library, assigning a unique name to the shape or the combination of shapes, and specifying values for the geometric parameters of the shape(s) in accordance with the real object. In other words, for the example above, the operator defines virtual objects A and B that are 3D models approximating the real objects 600 and 700 (i.e., pen and brush pot) in the object definition step. Please note that, within the object definition step, the order of these sub-steps (i.e., picking shapes, naming, and initializing parameters) are of no significance, except that the parameter initialization always has to be carried out after selecting the shape(s). For example, the naming could be performed either first or last.

The second step of teaching the robotic system 1 is to define one or more operations for instructing the robotic system 1 what to do. For example, an exemplary operation following the above example is to instruct the robotic system 1 to pick up the first real object 600 (i.e., pen) and then put the first real object 600 inside the second real object 700 (i.e., brush pot) so that the sharp end of the first real object 600 points upward. This operation definition step requires a preliminarily prepared operation module library 200, a part of the software system 40 as illustrated in FIG. 1b, which contains a number of operation modules 201. Similar to the use of the object model library 100, to specify the foregoing operation for the robotic system 1 to perform, the operator first selects one of the operation modules, say, PUT-INSIDE from the operation module library 200 which is about putting one thing into another thing.

Each operation module 201 is a software construct that is preliminarily prepared by a designer (e.g., a programmer). From the operator's point of view, each operation module 201 has a number of operation parameters that are also determined preliminarily by the designer of the operation module 201. Again using pseudo code, the PUT-INSIDE operation module could be represented as follows:

PUT-INSIDE (target1, target2, op3, op4, op5, . . . )

where target1, target2, op3, op3, etc., are all operation parameters of the operation module PUT-INSIDE. The meaning of these operation parameters are as follows:
target1 is a reference to a virtual object to be picked up by the robotic system1;
target2 is a reference to another virtual object into which target1 is placed;
op3 is a reference to where to hold the target1 so as to pick it up;
op4 is a reference to which end of target1 to go inside target2 first; and
op5 is a reference to which side of target2 to insert the target1.
   There are additional operation parameters referring to, such as,
where the axis of target2 is and what angle relative to the axis to insert target1;
the weight of target1 (so that the robotic system 1 knows how much force is required to lift target1);
the strength of the body of target1 (so that the robotic system 1 knows how much force to exert when grasping target1).
   As can be seen from above, these operation parameters provide various pieces of information that are relevant to the robotic system 1's fulfillment of the operation PUT-INSIDE. Therefore, different operation modules 201 may have different sets of operation parameters.

In the operation definition step, after the operator selects an operation module 201 from the operation module library 200, the operator needs to specify all of the operation parameters of the operation module 201. This could be achieved as follows, assuming that the software system 40 provides a graphic environment such as one offered by the AutoCAD®. For example, after the operator picks the operation module PUT-INSIDE, the software system 40, based on the operation parameters of PUT-INSIDE, would request the operator to specify each one of the operation parameters:
the operator specifies the virtual object A as target1 (by entering the name A or by clicking virtual object A in the graphic environment);
the operator specifies the virtual object B as target2 (by entering the name B or by clicking virtual object B in the graphic environment);
the operator specifies the shaded area in the middle of the virtual object A's cylindrical body (see FIG. 2d) as op3 (i.e., where to hold target1) by some point-and-click operations in the graphic environment;
the operator specifies the shaded area at an end of the virtual object A as op4 (i.e., which end of target1 to go inside target2 first) by some point-and-click operations in the graphic environment;
the operator specifies the shaded area at a top side of the virtual object B as op5 (i.e., which side of target2 to insert target1) by some point-and-click operations in the graphic environment; and
the operator specifies the dashed arrow as the axis of target2 and enters a value as an angle relative to the axis to insert the target1.
   For people of the related art, the rest of the details should be quite straightforward and therefore is omitted.

As a brief summary, during the operation definition step and for each operation to be performed by the robotic system 1, the operator selects at least an operation module 201 from the operation module library 200. Then, according to the pre-determined operation parameters of the operation module 201 selected, the software system 40 requests the operator to specify these operation parameters. These operation parameters involve one or more targets (i.e., virtual objects) to be manipulated and additional pieces of information about the virtual object(s) that are relevant to the operation. As described above, the specification of these operation parameters could all be achieved in a graphical environment such as a CAD system.

Please note that there are various different ways to implement the operation modules 201 and, depending how the operation modules 201 are implemented, there are also various ways regarding the robotic system 1 performs the operations as defined by operation modules 201 and as specified by their operation parameters. In one embodiment, each operation module 201 is a software routine or function (therefore, the operation module library 200 is a program library) and the operation parameters are the arguments passed to the routine or function. When the robotic system 1 is given one or more operation modules 201 along with specified operation parameters produced form the operation defunction step, the computing hardware 20 of the robotic system 1 executes the codes contained the routine or function. In an alternative embodiment, the routine or function mentioned above contains high-level, hardware independent instructions and these instructions have to be compiled into executable codes by a compiler having the knowledge of the hardware details of the manipulating hardware and computing hardware 20 of the robotic system 1.

The translation or compilation of the operation modules 201 is not the subject matter of the present invention, and there are quite a few teachings addressing similar topics. For example, U.S. Pat. Nos. 6,889,118, 7,076,336, and 7,302,312, all by Murray, IV, et al., provides a hardware abstraction layer (HAL) between robot control software and a robot's manipulating hardware such that the underlying hardware is transparent to the robot control software. This advantageously permits robot control software to be written in a robot-independent manner. Therefore, it could be imagined that the details of the operation modules 201 are programmed in the foregoing robot-independent manner. In yet another embodiment, the operation module 201 simply records all the specifications (i.e., values) of its operation parameters. The operation module 201 does not contain any high-level instruction or low-level executable code. It is the robotic system 1 that decides how to perform the operation based on the operation module 201 and its recorded specifications of operation parameters. In the previous embodiments, the intelligence of determining what to perform is embedded in the operation module itself and, for the current embodiment, the intelligence is completely built into the robotic system 1. As can be imagined, there are also some embodiments where part of the intelligence is embedded in the operation module 201 and part of the intelligence is built-into the robotic system 1.

No matter how the operation module is implemented, the operation modules and their operation parameters, together with the virtual object definitions and their geometric parameters, should provide adequate information for the robotic system 1 to carry out the operations intelligently. Please compare FIGS. 2e and 2f. As illustrated in FIG. 2e, when the virtual object A is far away from the virtual object B, the robotic system 1 should be able to plan a short trajectory as the robotic system 1 could decide that there is enough distance between the virtual objects A and B and that it could pick up the virtual object A directly. On the other hand, as illustrated in FIG. 2f, when the virtual object A is right next to the virtual object B, the robotic system 1 should be able to plan a more indirect trajectory as the robotic system 1 could decide that there is not enough distance between the virtual objects A and B and that it has to move the virtual object A first away from the virtual object B. The reason that the robotic system 1 is capable of making such an intelligent decision and trajectory planning is because the geometric parameters of the virtual objects A and B (such as their length and height, etc.) provide the required knowledge. The operation parameters, similarly, provides other relevant information so that the robotic system1 knows where to grasp the virtual object A and how to insert the virtual object A into virtual object B. Please note that the decision making and trajectory planning are not the subject matter of the present invention and there are numerous teachings in areas such as intelligent robot and artificial intelligence.

For the robotic system 1 to perform the taught operation on real objects, the robotic system 1 must associate the real objects to the defined virtual objects. In other words, when the robotic system 1 sees a real object, the robotic system 1 has to ‘recognize’ the real object as one of the defined virtual objects. If the real objects to be operated on has sufficiently different shapes and there is no need to rely on their colors, textures, or other features to differentiate them, then the primitive or complex shapes associated with the virtual objects and their geometric parameters are already enough for the robotic system 1 to recognize the real objects through the robotic system 1's optical perception means such as 3D laser scanner or camera. With the 3D laser scanner, the robotic system 1 is able to obtain a real object's three-dimensional data. The three-dimensional data then could be compared against the virtual objects' associated shapes and geometric parameters to see which virtual object most resembles the real object.

Even though the robotic system 1 only has a camera, the foregoing recognition is still possible. When the robotic system 1 sees, through the image capturing device 30, a real object, it first uses one or more captured images of the real object to construct a three-dimensional model of the real object and then compares the three-dimension model against the virtual objects' associated shapes and geometric parameters. There are already quite a few teachings in the field of computer graphic, image processing, etc. about constructing three-dimensional models from one or more two-dimensional images. For example, David G. Lowe teaches a computer vision system that can recognize three-dimensional objects from unknown viewpoints in single gray-scale images (“Three-dimensional object recognition from single two-dimensional images,” Artificial Intelligence, 31, 3 (March 1987), pp. 355-395).

However, to further enhance the recognition rate or to differentiate real objects having substantially similar shapes, the present invention provides an additional image association step. In this step, for each real object to be processed, at least a two-dimensional image 301 of the real object, taken from a perspective not necessarily identical to what is viewed from the image capturing device 30 of the robotic system 1 is provided and associated with the defined virtual object corresponding to the real object. These images 301 are usually preliminarily taken and stored in an image library 300, which is part of the software system 40 as illustrated in FIG. 1b. In other words, for each real object to be processed (and therefore for each virtual object defined), there is at least an image 301 of the real object in the image library 300. Following the foregoing example, the image association step could be represented using pseudo codes as follows:

Image Association
Image1: A;
Image2: B.
   where Image1 is a two-dimensional image of the real object 600 corresponding to the virtual object A while Image2 is a two-dimensional image of the real object 700 corresponding to the virtual object B, as shown in FIG. 2g. In an alternative embodiment, the image association step is actually combined with the object definition step, as represented by the pseudo codes below:

Virtual Object
A: CONE+CYLINDER=Image1;
B: POT=Image2;

As mentioned, during its operation, the robotic system 1 will always try to ‘recognize’ a real object. Without the image association step, the robotic system 1 could only rely on the primitive or complex shapes associated with the virtual objects and their geometric parameters. With the image association step, the recognition of a real object is further supported by matching some captured images (by the image capturing device 30) of the real object to the preliminarily taken image(s) associated with all virtual objects using some image processing means. If there is one virtual object whose associated image(s) most resembles the real object's captured image(s). the real object is ‘recognized’ as the specific virtual object.

The image processing means is not the subject matter of the present invention and there are many teachings dealing with identifying three-dimension objects using two-dimensional images. For example, Daniel P. Huttenlocher et al. teaches an algorithm to recognize an object by comparing a stored two-dimensional view of the object against an unknown view, without requiring the correspondence between points in the views to be known a priori (“Recognizing Three-Dimensional Objects by Comparing Two-Dimensional Images,” cvpr, pp. 878, 1996 IEEE Computer Society Conference on Computer Vision and Pattern Recognition (CVPR'96), 1996).

Please note that the object model library 100, the operation module library 200, and the image library 300 are usually pre-installed in the software system 40 before the operator uses the software system 40 to generate a task description (see FIG. 2g) to teach the robotic system 1 what to do. However, both the object model library 100 and the operation module library 200 have some built-in object models 101 (such as those primitive shapes) and operation modules 201. In contrast, the images 301 in the image library 300 could be either prepared in advance or added later during the object definition step or the image association step. Please note that the images 301 could be taken by a separate image capturing device other than the image capturing device 30 of the robotic system 1.

Please note that the present invention is about the generation of a task description for a robotic system having an optical perception means so that the robotic system knows how to process at least a real object. However, based on the task description, how the robotic system actually perform the task is not the subject matter of the present invention and therefore most of the details are omitted in the present specification. As can be imagined, there are various ways to perform the task. Taking the recognition of a real object as example, one robotic system may simply and completely rely on the preliminarily taken images while another robotic system may additionally utilize the geometric information of the virtual objects as known priori in achieving higher successful rate of recognition. Even though the details regarding the execution of the task description during the robotic system's operation are omitted, there are plenty of prior teachings about ways of utilizing the information contained in the task description to warrant a successful undertaking of the operation as specified in the task description.

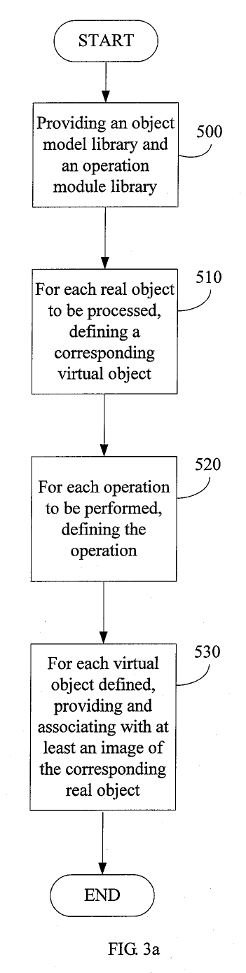

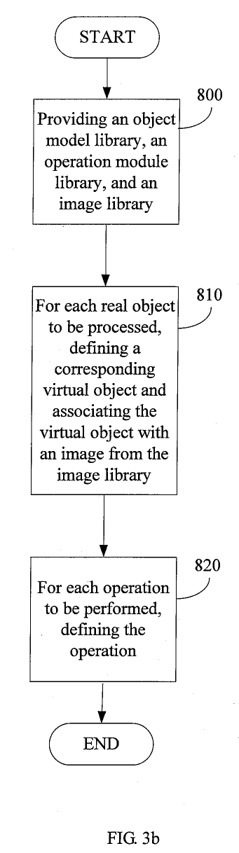

FIG. 3a provides a flow diagram showing the steps of teaching the robotic system 1 (i.e., generating a task description) to handle one or more real objects according to an embodiment of the present invention. As illustrated, in step 500, an object model library 100 and an operation module library 200 are provided. For each real object to be processed by the robotic system 1, there is at least an object model 101 defining a three-dimensional shape at least geometrically similar to the real object or there are two or more object models 101 where their defined shapes could be combined to be at least geometrically similar to the real object. Each object model 101 contains at least a geometric parameter. Also, for each operation to be performed on the real objects, there is at least an operation module 201 contained in the operation module library 200. Each operation module 201 has a number of pre-determined operation parameters for specifying the at least a virtual object as target(s) of the operation and for specifying additional pieces of information about the virtual object(s) that are relevant to the operation.

Then, in step 510, for each real object to be processed, the definition of a virtual object is provided. The virtual object definition contains a unique name for the virtual object, a reference to an object model 101 or the combination of a number of object models contained in the object model library 100, and specifications of values for the geometric parameters for the object model(s) in accordance with the real object. After this step, each real object to be processed is in effect represented by a virtual object that is substantially and geometrically similar to the real object.

Subsequently, in step 520, for each operation to be performed on the real objects, a definition of the operation is provided. The operation definition contains a reference to an operation module 201 contained in the operation module library 200, and specification of the pre-determined operation parameters of the operation module 201. After this step, each operation to be performed by the robotic system 1 is in effect described by an operation module 201 and its specified operation parameters.

Finally, in step 530, for each virtual object defined in step 510, at least a two-dimensional image previously taken of the real object represented by the virtual object is provided and associated with the virtual object. After this step, a task description for the robotic system 1 is completed, as shown in FIG. 2g, which contains one or more virtual object definitions corresponding to the real object(s) to the processed, one or more operation definitions corresponding the operation(s) to be performed on the real object(s), and one or more images of the real object(s) associated with the corresponding virtual object(s).

FIG. 3b shows the major steps of another embodiment of the present invention. It is very much similar to the previous embodiment except that (1) the two-dimensional images 301 are prepared in advance and provided in an image library in the initial step 800; and (2) the association of the images 301 to the virtual objects are conducted together in the object definition step 810. The operation definition step 820 is identical to the step 520 of the previous embodiment.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of teaching a robotic system having an optical perception means to perform at least an operation on at least a real object, said method comprising the steps of:
providing an object model library containing at least an object model describing a three-dimensional shape, and providing an operation module library containing at least an operation module describing an operation, wherein each object model comprises a plurality of geometric parameters of said three-dimensional shape; and each operation module comprises a plurality of operation parameters regarding at least a target to be operated and a plurality of pieces of information relevant to said operation;
defining a virtual object to represent a real object to be operated by said robotic system, wherein said virtual object definition is associated with a unique name and an object model of said object model library; said three-dimensional shape described by said object model is substantially and geometrically similar to said real object, and said plurality of geometric parameters of said object model are specified in accordance with said real object; and
defining an operation to be performed by said robotic system on at least said real object, wherein said operation definition is associated with an operation module of said operation module library, said target of said operation parameters is specified to be said unique name of said virtual object representing said real object, and said pieces of information of said operation parameters are specified in accordance with said virtual object and said operation.

2. The method according to claim 1, wherein said optical perception means comprises a 3D laser scanner.

3. The method according to claim 1, wherein said optical perception means comprises an image capturing device.

4. The method according to claim 3, further comprising the steps of:
providing at least a two-dimensional image preliminarily taken of said real object to be processed by said robotic system; and
associating said two-dimensional image to said virtual object representing said real object.

5. The method according to claim 4, wherein said two-dimensional image is associated with said virtual object when said virtual object is defined.

6. The method according to claim 4, wherein said two-dimensional image is taken by said image capturing device of said robotic system.

7. The method according to claim 3, further comprising the step of:
providing an image library containing at least a two-dimensional image preliminarily taken of said real object to be processed by said robotic system; and
associating said two-dimensional image to said virtual object representing said real object.

8. The method according to claim 7, wherein said two-dimensional image is associated with said virtual object when said virtual object is defined.

9. The method according to claim 7, wherein said two-dimensional image is taken by said image capturing device of said robotic system.

10. The method according to claim 1, wherein said method is conducted in a graphical environment.

11. The method according to claim 10, wherein said graphic environment is executed on said robotic system.

12. The method according to claim 1, wherein said three-dimensional shape is a primitive shape.

13. The method according to claim 1, further comprising:
defining a virtual object for a real object to be processed by said robotic system, wherein said virtual object definition is associated with a unique name and at least two object models of said object model library; said three-dimensional shapes described by said object models are substantially and geometrically similar to said real object after being combined together, and said plurality of geometric parameters of said object models are specified in accordance with said real object.

14. The method according to claim 13, wherein at least one of said three-dimensional shapes of said object models is a primitive shape.
